(19) United States
(12) Patent Application Publication
(10) Pub. No.: US 2026/0143062 A1
(43) Pub. Date: May 21, 2026

(54) METHOD FOR DETERMINING AT LEAST ONE TARGET ACTION FROM A SET OF ACTIONS ABLE TO BE EXECUTED ON AN ELECTRONIC TERMINAL

(71) Applicant: ORANGE, Issy-les-Moulineaux (FR)

(72) Inventors: Tiphaine MARIE, Châtillon (FR); Mickaël LE TROCQUER, Châtillon (FR); Nabil DITINI, Châtillon (FR); Cédric FLOURY, Châtillon (FR)

(21) Appl. No.: 19/118,558

(22) PCT Filed: Oct. 9, 2023
(86) PCT No.: PCT/EP2023/077871

§ 371 Date: Apr. 4, 2025

(30) Foreign Application Priority Data
Oct. 11, 2022 (FR) FR2210398

(51) Int. Cl. H04M 1/72454; G06V 30/32

(52) U.S. Cl. CPC H04M 1/72454; G06V 30/32

(57) ABSTRACT

A method for determining at least one target action from a set of actions able to be executed on an electronic terminal. Such a method includes: obtaining a current digital context of use of the electronic terminal, including data related to a current use of the terminal; analyzing at least one criterion of similarity between the current digital context and a plurality of previously stored reference contexts, on the basis of the data, delivering at least one context of highest degree of similarity with the current digital context from the reference contexts, referred to as close context; and determining the at least one target action by comparing the current digital context and the at least one close context.

### TECHNICAL FIELD

The invention relates to the field of electronic terminals capable of executing a plurality of applications. More particularly, the invention relates to the implementation of smart assistance systems, configured to accompany a user during use of an electronic terminal.

### PRIOR ART

Electronic terminals called smart electronic terminals (computers, smartphones, tablets, etc.) have computing capabilities that allow them to run more and more applications simultaneously, and communication interfaces that allow them to access more and more information. Thus, the range of actions that a user can perform using an electronic terminal is now very wide, and constantly growing.

This multiplicity of functionalities of recent electronic terminals, however, has the downside of an increasing complexity in using these terminals. In this context, the development of assistance systems is very relevant: installed on an electronic terminal, such assistance systems aim at automatically offering help or suggestions to the user, with regard to the common use of the electronic terminal (for example, to help the user who seems to be having difficulty using an application, to offer him automation of a repetitive task, the automatic completion and writing of replies to emails, etc.).

However, existing assistance systems still have room for improvement in many aspects. For example, the data on which these systems rely to determine an assistance proposal is sometimes insufficient, or limited to too narrow a scope. Furthermore, many of these existing systems are relatively rigid, and do not provide for example mechanisms allowing them to learn the habits of a user of an electronic terminal. The assistance supposedly obtained via these existing systems is therefore at best rudimentary, and most often unsuitable for the needs of the user who finds himself exposed to an overload of information that is of little use or useless, likely to tire him or waste his time. The effect obtained is therefore the opposite of that sought, and potentially counterproductive.

There is therefore a need for a solution to improve existing assistance systems.

### SUMMARY OF THE INVENTION

The present technique allows to propose a solution aimed at overcoming certain disadvantages of the prior art. According to one aspect, the present technique relates indeed to a method for determining at least one target action from a set of actions able to be executed on an electronic terminal. Such a method comprises at least one iteration of the following steps:
obtaining a current digital context of use of the electronic terminal, said current digital context comprising data related to a current use of said electronic terminal;
analyzing at least one criterion of similarity between said current digital context and a plurality of previously stored reference contexts, said analysis being carried out on the basis of said data and delivering, from said reference contexts, at least one context of highest degree of similarity with said current digital context, referred to as similar context;
determining said at least one target action by comparing said current digital context and said at least one similar context.

In this way, the proposed technique allows to automatically perform a prediction of actions having a high probability of being of interest to a user of the electronic terminal at a given moment, based on a current activity of the user on this terminal and/or his habits, thus allowing for example the implementation of smart assistance systems that are both flexible and efficient.

In a particular embodiment, said data comprise at least temporal data, and/or application data, and/or lexical data, and/or data representative of a state of interaction of a user with said electronic terminal.

In this way, many data of different types are taken into account to characterize a digital context, thus allowing the implementation of predictions that are more precise and therefore better adapted to the needs of the user.

In a particular embodiment, said analysis of at least one similarity criterion is a multi-criteria analysis comprising the determination of similarities between said current digital context and said reference contexts on a plurality of criteria among at least:
a number and type of applications and/or activities performed;
themes and/or entities extracted from said contexts;

elements of dialogue identified within said contexts;
time periods of use associated with said contexts;
possible actions associated with said contexts.

In this way, the similarity analysis is not limited to a single criterion and is based on a wide variety of data, thus significantly increasing the probability of delivering predictions that are truly relevant to the user.

According to a particular feature of this embodiment, said analysis takes into account a number of criteria satisfied by said reference contexts during said multi-criteria similarity analysis.

In this way, a weighting of the results of the multi-criteria similarity analysis can be carried out, for example to value the reference contexts that have high similarity scores on a plurality of criteria.

In a particular embodiment, said determination step comprises determining a plurality of target actions, and ranking said target actions by degree of relevance.

In this way, the present technique not only allows to predict several target actions likely to be of interest with regard to a use of the electronic terminal by a user, but also to automatically highlight those which seem most relevant to the user.

In a particular embodiment, said target actions belong to the group comprising at least:
launching a particular application installed on the electronic terminal;
launching a particular functionality of said electronic terminal, in relation to at least one of said data of said current digital context.

In this way, a wide variety of target actions from the most general to the most specific-are likely to be determined within the framework of the present technique.

In a particular embodiment, said reference contexts are generated and stored during an initialization phase, on the basis of a preliminary analysis of activity on said electronic terminal.

In this way, the method according to the present technique is based on taking into account and in-depth learning of the user's habits, allowing to further increase the probability of predicting actions that are adapted and particularly relevant to the user.

According to a particular feature of this embodiment, said initialization phase comprises, prior to said preliminary activity analysis, a step of indexing the content of said electronic terminal.

In this way, the analysis processing operations of the user activity, whether performed during the initialization phase or when obtaining a current digital context, can be implemented more efficiently, for example more quickly or while consuming less computing power.

In a particular embodiment, said method further comprises the restitution on the electronic terminal of a suggestion for execution of said at least one target action.

In this way, the user has simple and rapid access, for example on a screen of his communication terminal, to suggestions for relevant actions allowing him to be effectively supported in his use of the electronic terminal.

According to a particular feature of this embodiment, said step of determining a target action takes into account a history of target actions executed following execution suggestions restituted during an implementation of at least one previous iteration of said steps of obtaining, analyzing, determining and restitution.

In this way, the target actions selected by a user following an automatic suggestion made using the method according to the present technique can be enhanced during subsequent iterations of the method, the relevance of these target actions having been confirmed.

According to another aspect, the present technique also relates to a device for determining at least one target action from a set of actions able to be executed on an electronic terminal. Such a device comprises:
means for obtaining a current digital context of use of said electronic terminal, said current digital context comprising data related to a current use of said electronic terminal;
means for analyzing at least one criterion of similarity between said current digital context and a plurality of previously stored reference contexts, said analysis being carried out on the basis of said data and delivering at least one context of highest degree of similarity with said current digital context from said reference contexts, referred to as similar context;
means for determining said at least one target action by comparing said current digital context and said at least one similar context.

According to another aspect, the proposed technique also relates to a computer program product that can be downloaded from a communication network and/or stored on a computer-readable medium and/or able to be executed by a microprocessor, comprising program code instructions for executing a method for determining at least one target action from a set of actions able to be executed on an electronic terminal as described above, when executed on a computer.

The proposed technique also relates to a computer-readable recording medium on which is recorded a computer program comprising program code instructions for executing the steps of the method as described above, in any of its embodiments.

Such a recording medium may be any entity or device capable of storing the program. For example, the medium may include a storage medium, such as a ROM, for example a CD ROM or a microelectronic circuit ROM, or a magnetic recording medium, for example a USB key or a hard disk.

On the other hand, such a recording medium may be a transmissible medium such as an electrical or optical signal, which can be conveyed via an electrical or optical cable, by radio or by other means, so that the computer program contained therein is able to be executed remotely. The program according to the invention may in particular be downloaded over a network, for example the Internet.

The different embodiments mentioned above can be combined with each other for the implementation of the invention.

### FIGURES

Other features and advantages of the invention will appear more clearly upon reading the following description of a preferred embodiment, given as a simple illustrative and non-limiting example, and the appended drawings, among which:

FIG. 1 illustrates the main steps of the method for determining at least one target action from a set of actions able to be executed on an electronic terminal, in a particular embodiment of the proposed technique;

FIG. 2 shows an example of multi-criteria analysis of similarity between a current context and a plurality of reference contexts, in a particular embodiment of the proposed technique;

FIG. 3 describes a simplified architecture of an electronic device for implementing the proposed technique, in a particular embodiment.

### DETAILED DESCRIPTION OF THE INVENTION

This application addresses some of the above-mentioned disadvantages.

The proposed technique relates indeed, according to a first aspect, to a method for determining at least one target action from a set of actions able to be executed on an electronic terminal (for example a fixed or portable personal computer, a digital tablet, a smartphone, a connected watch, etc.).

Executable actions are understood to mean all actions that can be implemented by means of the electronic terminal, whether through functionalities or native applications available on the electronic terminal (for example via its operating system) or through third-party applications installed on the electronic terminal. In an illustrative and non-limiting manner, such executable actions comprise for example:
launching a particular application;
launching a particular activity within a given application (for example launching a search engine within an Internet browser) ;
making a phone call to a contact;
sending a message to a contact;
locating a place via a mapping application;
starting a timer;
changing configuration settings (for example adaptation of display preferences—position, size, etc.
depending on the usage environment—multi-screen or single screen-of the electronic terminal) ;
sending a request to a third-party terminal—for example to a connected object—in order to trigger a predetermined action (for example sending a request to a connected bulb to control its switching on or off, to a connected screen to change its display settings, etc.);
etc.

Target action means a particular action among the set of executable actions whose probability is high that it is of interest to a user of the electronic terminal, with regard to his current (that is to say ongoing) or habitual use of this terminal.

The present technique therefore aims at implementing an automatic determination-or, in other words, a prediction-of actions likely to interest the user of the electronic terminal at a given moment, based on an activity in progress of the user on this terminal. A target action can thus for example also be qualified as a recommended, appropriate, or relevant action.

To this end, as detailed below, it is proposed within the framework of the present technique to rely on a comparison between a current digital context of use of the electronic terminal and digital contexts of references previously stored within an accessible data structure of the electronic terminal. Such data structure (typically a database) is for example stored locally in a memory of the electronic terminal, or within a remote server to which the electronic terminal can connect.

“Digital context”, more simply called “context” in the remainder of this document, means in the framework of the present technique a set of data representative of a session of use of the electronic terminal grouping activities which, over a continuous time block, have a certain coherence between them. A change in the types of applications used on the electronic terminal-for example the transition from use of business applications to use of entertainment applications-can thus be representative of a change of context. Such changes of context, and therefore ultimately the contexts themselves, can be detected automatically via user activity analysis techniques.

According to the proposed technique, a context is more particularly defined by a set of contextual features, that is to say data related to a current use of the electronic terminal, comprising for example temporal data, application data, lexical data, and/or data representative of a state of interaction of the user with the electronic terminal.

Temporal data comprise, for example, information relating to the period of use of the electronic terminal associated with the context: for example, start time and end time, time of day (morning, afternoon, etc.) , of the week (specific day), of the month, and/or of the year during which the electronic terminal is used, duration of use, etc.

Application data comprise, for example, information relating to the applications launched and/or the native functionalities used by the user: type (word processing, spreadsheet, browser, mapping application, telephone call, etc.), name of the application, etc. Such application data may comprise data enabling the user to be physically located (for example, directly, via location data such as GPS data, or indirectly, for example, via an IP address associated with the user's terminal).

Lexical data comprise, for example, information relating to themes and/or entities identified within textual data and/or images displayed on a screen of the electronic terminal when used: for example, professional themes (accounting, production, communication, etc.) , geographical locations, names of companies, departments within an organization, people, etc.

The data representing a state of interaction of the user with the electronic terminal comprise in particular information from input peripherals (for example keyboard, touch screen, pointing device, etc.) of the terminal, such as for example information according to which the user has clicked on a graphical interface element displayed on the screen, used a vertical and/or horizontal scrolling functionality, entered text in an input area, etc., or even on the contrary information according to which the user has been inactive for a certain duration.

According to a particular feature, information representative of links between these different types of data is also associated with a context, such as for example the period and duration of use of a given application, the fact that a given entity or theme is identified in a given application, the order of use of the applications launched, etc.

In all the figures of this document, identical elements and steps are designated by the same reference.

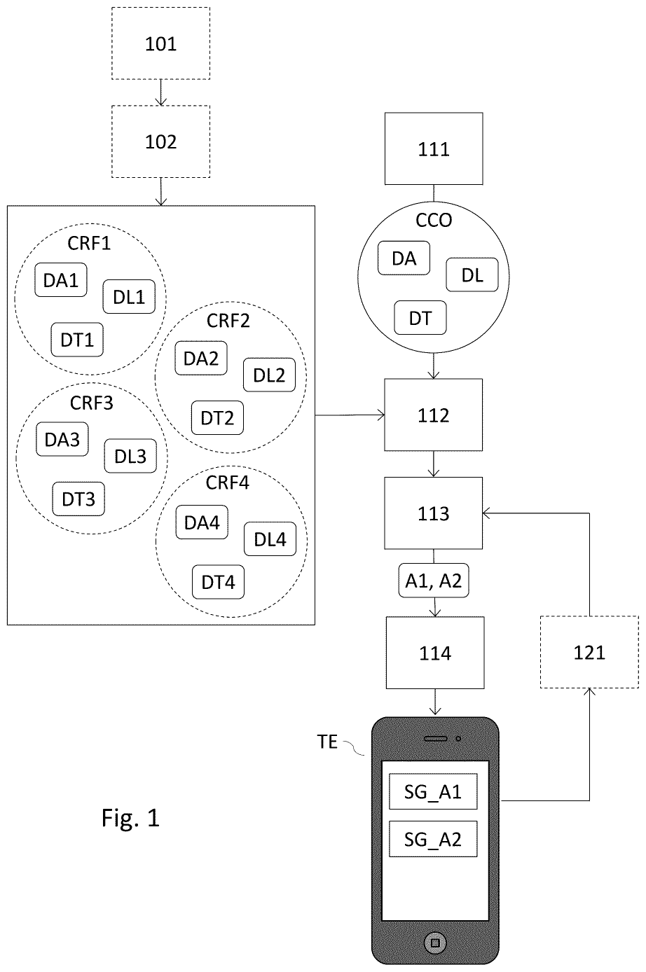

The general principle of the method for determining at least one target action will now be presented in relation to FIG. 1 in a particular embodiment of the proposed technique. This method is implemented by an electronic device which may or may not be integrated into the user's electronic terminal, as described below.

In a step 111, the electronic device obtains a current context CCO of use of the electronic terminal TE. More particularly, as presented previously, such a context CCO is defined by a set of data, comprising for example at least temporal data DT, application data DA, and lexical data DL related to a current use of said electronic terminal. Such data can be obtained by different means. For example, in a particular embodiment, the temporal and application data as well as data representative of a state of interaction of the user with the electronic terminal are obtained by means of application programming interfaces (API) made available by the operating system of the electronic terminal, and the lexical data are obtained by the combination of character recognition techniques and automatic language processing techniques (for example of the LDA type, for Latent Dirichlet Allocation) allowing to extract from what is displayed on a screen of the electronic terminal (texts, images, etc.) themes, names of entities (places, companies, people, etc.) , dialogue elements, etc. These different means for obtaining the data characterizing the current context are for example activated via an application executed on the electronic terminal and dedicated to the implementation of the method according to the present technique.

The data associated with the current context CCO of use of the electronic terminal thus obtained then serve as a basis, in a step 112, for the implementation of an analysis of at least one criterion of similarity between the current context CCO and a plurality of reference contexts (CRF1, CRF2, CRF3, CRF4) previously stored, themselves characterized by their own contextual data sets (for example, the reference context CRF1 is associated with temporal data DT1, application data DA1, and lexical data DL1, etc.) and possibly already themselves associated with predetermined actions (for example the opening of a leave management application). According to a particular feature, such an analysis is multi-criteria, a plurality of criteria (that is to say at least two) then being taken into account in order to identify, among known reference contexts, the one or ones that best correspond to the current context of use of the electronic terminal.

In a particular embodiment, the reference contexts are identified, generated and stored during an initialization phase during which a continuous analysis step 102 of the user's activity on the electronic terminal is implemented over a given period (for example for a few hours, a few days, or more). This initialization phase optionally comprises, prior to the continuous analysis 102 and in order to make it more efficient, a step 101 of indexing the content of the electronic terminal, aiming in particular at listing the applications installed on the terminal, as well as the services and/or data sources to which it has access. This initialization phase on the electronic terminal side, and therefore the associated steps 101 and 102, are optional, the reference contexts (CRF1, CRF2, CRF3, CRF4) may for example also have been created manually, at a shared server accessible from the user's electronic terminal but also from other electronic terminals of other users, according to logical or coherent scenarios of use of an electronic terminal.

In a particular embodiment, the multi-criteria analysis carried out in step 112 comprises the determination of similarities between the current context and the reference contexts on several criteria among at least the following criteria:
a number and type of applications and/or activities associated with said contexts;
themes and/or entities extracted from said contexts;

elements of dialogue identified within said contexts;
time periods of use associated with said contexts;
possible actions associated with said contexts.

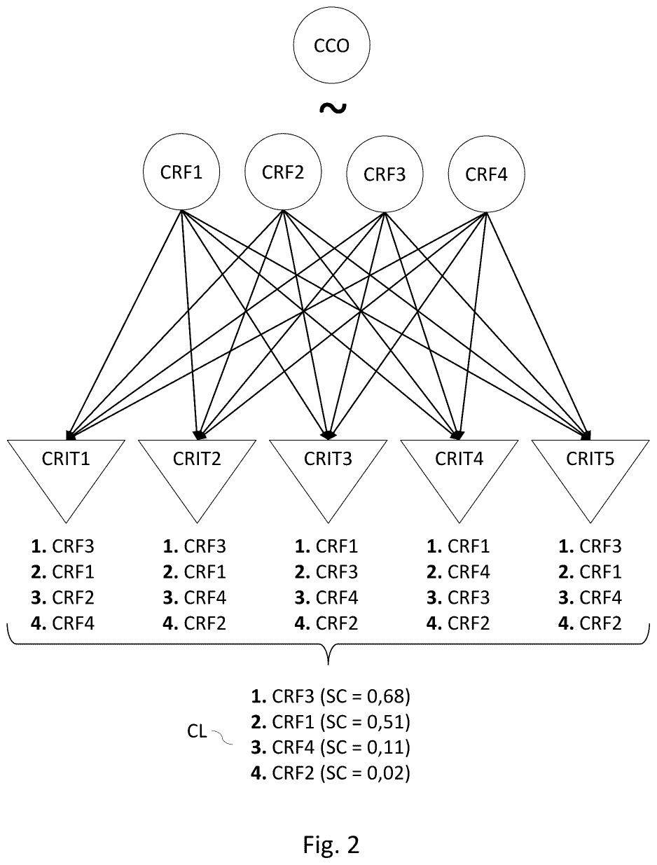

Such a multi-criteria analysis according to step 112 is for example schematically illustrated in relation to FIG. 2. The examples of different criteria previously introduced and presented in more detail below are given in an illustrative and non-limiting manner.

Thus, a first criterion CRITI considered during the multi-criteria similarity analysis may have as its object a number and a type of applications and/or activities carried out within these applications. In other words, a similarity analysis is carried out in the applications and/or activities executed: the list of applications executed within the current context CCO is compared with a list of applications associated with each stored reference context (CRF1, CRF2, CRF3, CRF4). In a complementary manner, the type of activity carried out within these applications may also be taken into account within the framework of such a comparison. More particularly, for each reference context, it is thus possible to calculate a similarity score with the current context (and therefore to establish a ranking of the reference contexts by degree of similarity, on the basis of the criterion CRIT1). For example, if the application data associated with the current context shows that three applications APP1, APP2 and APP3 are currently running on the electronic terminal (that is to say used by the user), that a first reference context is associated with the four applications APP1, APP2, APP3 and APP4 and that a second reference context is associated with the four applications APP1, APP5, APP6 and APP7, the similarity score of the first reference context will be higher than that of the second reference context (three applications in common with the current context for the first reference context, against only one for the second reference context).

A second criterion CRIT2 considered during the multi-criteria similarity analysis may have as its object the named themes and/or entities. In other words, a similarity analysis is carried out, said analysis consisting of determining whether lexical data associated with the current context CCO (in particular entities and/or themes), obtained via recognition techniques implemented on the information displayed on the screen of the electronic terminal, are already associated (in whole or in part) with some of the stored reference contexts.

In a relatively similar manner, a third criterion CRIT3 considered during the multi-criteria similarity analysis may have identified dialogue elements as its object. In other words, a semantic similarity analysis is carried out, said analysis consisting of determining whether lexical data representative of dialogue elements, obtained via recognition techniques implemented on the information displayed on the screen of the electronic terminal, are close, from a semantic point of view, to dialogue elements already associated with some of the stored reference contexts. For example, with regard to this criterion, a reference context comprising the lexical datum of the type of dialogue element “Have you requested your leave in leave-management.app?” is considered to be close to the current context CCO in which the dialogue element “Can you request your vacation in the tool?” was identified.

A fourth criterion CRIT4 considered during the multi-criteria similarity analysis may have as its object the search for similarities in the time periods associated with the contexts. Such a criterion allows in some way to extrapolate the notion of habit or routine of the user. More particularly, the temporal data associated with the current context, representative of a moment of use, are compared with those associated with the different reference contexts to look for a similarity in the moment. Such a search for similarity can be carried out at different levels of granulometry: for example beginning, middle, or end of year/month/week/day, particular day (Wednesday), or even on a more precise schedule (for example at 11:45 a.m.).

A fifth criterion CRIT5 considered during the multi-criteria similarity analysis may have as its object the search for similarities in possible actions. For example, if entities of the type “person name” are identified both in the current context and in a reference context, without these entities necessarily referring to the same person, common possible actions exist between these two contexts (for example “make a call to the identified person” or “open the company directory”), also representative of a certain degree of similarity between these contexts.

The analysis of at least one similarity criterion according to step 112 thus allows to identify and deliver, among the reference contexts, at least one context with a highest degree of similarity with the current digital context.

FIG. 2 illustrates a particular embodiment in which the similarity analysis allows, for example, to establish, in a first step, a ranking of the reference contexts (CRF1, CRF2, CRF3, CRF4) by degree of similarity with the current context CCO for each criterion (CRIT1, CRIT2, CRIT3, CRIT4, CRIT5) considered individually (on the basis, for example, of similarity scores calculated for each reference context, with regard to the criterion considered). In a second step, in the case of multi-criteria analysis, these different rankings by criterion are consolidated to deliver an overall ranking CL of the stored contexts by degree of similarity with the current context CCO. According to a particular feature of the proposed technique, such consolidation can in particular integrate thresholding and/or weighting mechanisms aimed at penalizing or, on the contrary, favoring certain reference contexts, according to their similarity scores or their rankings by criterion. For example, a score of a reference context according to a given criterion not exceeding 50% similarity with the current context can be reduced to the value zero (penalization of the reference context), while a reference context appearing at the top of the ranking (for example in first place) on a plurality of criteria can be given more weight than the others when calculating its consolidated score SC (favoring the reference context). In other words, according to a particular feature, the global ranking CL takes into account the number of criteria satisfied by the reference contexts during the multi-criteria similarity analysis.

Returning to FIG. 1, in a step 113, the current context CCO is compared with at least one reference context of highest degree of similarity delivered in step 112 (for example selected at the top of the ranking CL, when such a ranking has been established) in order to determine at least one target action (A1, A2) whose execution is likely to be of interest to the user. In the remainder of this document, these reference contexts of highest degree of similarity are more simply called “similar contexts”, according to a shortcut used only for the purposes of simplification and clarification.

For example, if the current context obtained in step 111 shows that the user is currently using three applications APP1, APP2 and APP4, but that four applications APP1, APP2, APP3 and APP4 are associated with a similar context detected in step 112, a target action may for example correspond to the launch of the application APP3 (not present in the current context but present in the similar context identified). In a complementary manner, it is also possible in a particular embodiment, in addition to comparing the simultaneously executed applications, to also trace application execution sequences over a given time (for example the user reads an email via a messaging application, then launches a videoconferencing application, then opens a business leave management application), in order to propose a target action corresponding to the launch of an application identified within a similar context as a logical continuation of the application execution sequence detected within the current context. A target action may also correspond to the launch of a particular functionality of the electronic terminal, in relation to at least one temporal, application and/or lexical datum of the current context, if for example the launch of such a functionality on a similar datum has been detected for a similar context (for example initiating a telephone call to an identified person, adding an event to a digital calendar on the basis of a detected date, locating a place detected by means of a mapping service, etc.). The proposed technique therefore allows, on the basis of an analysis of the common points and differences between the current context and similar reference contexts (in particular on the basis of the temporal, application and lexical data respectively associated with these contexts), to identify at least one target action likely to be of interest to the user.

In a particular embodiment, when a plurality of target actions (that is to say at least two) are thus detected, these target actions are classified by degree of relevance (or at least by degree of probability of relevance) for the user. Such a classification between target actions can for example be established on the basis of the classification of the reference contexts delivered in step 112: a target action will be considered all the more relevant as the reference context from which it comes has a high degree of similarity with the current context. Other mechanisms for classifying target actions can also be implemented within the framework of the present technique. The classification of target actions by degree of relevance serves for example as a criterion for choosing an order of restitution of suggestions for execution (SG_A1, SG_A2) of these actions on a screen of the electronic terminal TE: the higher the degree of relevance of a target action, the higher the suggestion for execution of the target action is displayed within a list of suggested actions presented to the user.

In a particular embodiment, the suggestions (SG_A1, SG_A2) of the determined target actions are returned in a step 114 on the electronic terminal, automatically (for example via a notification system), and/or at the express request of the user (for example via a request for suggestions made by means of a dedicated application). These suggestions (SG_A1, SG_A2) take the form, for example, of a clickable graphical interface element (for example button, link) associated with a label explicitly describing the corresponding target action (for example “Launch the ‘My-Leave’ application”).

The selection, by a user, of a suggestion of a target action returned in step 114—in other words, the fact that a user follows a proposal made by the assistance system according to the present technique by choosing to execute the associated target action generally testifies to a high degree of relevance of this target action. Also, in a particular embodiment of the proposed technique, it is proposed to trace, in a step 121, this type of events. The choice of the user to follow up on a suggestion of a target action by launching the execution of this action is therefore stored in a data structure, with associated data (nature of the selected target action, current context and similar reference context associated, etc.). Such a history of previously executed target actions following execution suggestions can then in particular be taken into account during step 113 of determining a target action for a following iteration of the method, for example to enhance target actions frequently selected by the user in similar contexts. As illustrated in FIG. 1, a feedback loop is thus implemented, which contributes, in the same way as the multi-criteria nature of the similarity analysis, to making the assistance system according to the proposed technique more efficient than the systems of the prior art.

When the operating system of the electronic terminal allows multi-user use that is to say the possibility of creating several user accounts and of associating a session of use of the terminal with a particular user account among the plurality of available user accounts—the method for determining at least one target action as previously described in any of its embodiments may be dependent on the active user account. In other words, in a particular embodiment of the proposed technique, the determination of at least one target action from a set of executable actions takes into account the active user account on the electronic terminal at the time of obtaining the current context. In particular, according to a particular feature, the current context and the reference contexts to which it is compared are associated with the same user account during the implementation of the method. In this way, the proposed technique allows to obtain suggestions for actions differentiated by user, that is to say according to the uses and habits specific to each user of the electronic terminal.

According to another aspect, the proposed technique also relates to a device for determining at least one target action from a set of actions able to be executed on an electronic terminal, capable of implementing the method previously described in any of its embodiments. More particularly, such an electronic device according to the present technique comprises:
means for obtaining a current digital context of use of the electronic terminal, the current digital context comprising at least data related to a current use of the electronic terminal;
means for analyzing at least one criterion of similarity between the current digital context and a plurality of previously stored reference contexts, on the basis of said data, the analysis delivering at least one context of highest degree of similarity with the current digital context from said reference contexts, referred to as similar context;
means for determining said at least one target action by comparing the current digital context and said at least one similar context.

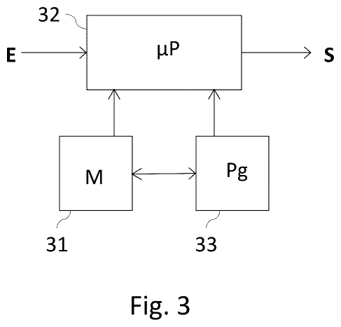

FIG. 3 schematically and simplifiedly represents the structure of such an electronic device, in particular embodiment. According to a first implementation, this electronic device can be integrated into, or merged with, the electronic terminal (for example the computer, the tablet, the smartphone, etc.) on which it is desired to implement the assistance system. According to a second implementation, this electronic device is integrated into, or merged with, another device that cooperates with the user's electronic terminal (this other device is for example a home gateway, also called an “Internet box”).

The electronic device according to the proposed technique comprises for example a memory 31 consisting of a buffer memory M, a processing unit 32, equipped for example with a microprocessor up, and controlled by the computer program Pg 33, implementing the analysis method according to the invention.

Upon initialization, the code instructions of the computer program 33 are loaded into the buffer memory before being executed by the processor of the processing unit 32. The processing unit 32 receives as input E, for example, usage data originating, for example, from various software and/or hardware probes (for example, probe for analyzing the system activity of the terminal, probe for scanning at least one input peripheral associated with the terminal, etc.). These data change over time, depending on the user's activity on his electronic terminal.

The microprocessor of the processing unit 32 then performs the steps of the method for determining at least one target action, according to the instructions of the computer program 33, to deliver at output S at least one target action whose execution is likely to interest the user of the electronic terminal with regard to his current use of this terminal. More particularly, the microprocessor 32 obtains a current digital context of the user of the electronic terminal from the usage data received at input E, then it implements an analysis of at least one criterion of similarity of this current context with a plurality of previously stored reference contexts in order to identify among these reference contexts at least one context close to the current context, then used as a basis for comparison for determining said target actions.

1. A method for determining at least one target action from a set of actions able to be executed on an electronic terminal, said method being implemented by a device and comprising at least one iteration of:
obtaining a current digital context of use of said electronic terminal, said current digital context comprising data related to a current use of said electronic terminal, at least part of said data being obtained by the implementation of character recognition techniques and automatic language processing techniques on elements displayed on a screen of said electronic terminal;
analyzing at least one criterion of similarity between said current digital context and a plurality of previously stored reference contexts, said analysis being carried out at least on the basis of said part of said data obtained by the implementation of character recognition techniques and automatic language processing techniques on elements displayed on a screen of said electronic terminal, said analysis delivering at least one context of highest degree of similarity with said current digital context from said reference contexts, referred to as similar context;
determining said at least one target action by comparing said current digital context and said at least one similar context.

2. The method according to claim 1, wherein said data comprise at least temporal data, application data, lexical data, and/or data representative of a state of interaction of a user with said electronic terminal.

3. The method according to claim 1, wherein said analysis of at least one similarity criterion comprises a multi-criteria analysis comprising a determination of similarities between said current digital context and said reference contexts on a plurality of criteria among at least:
a number and type of applications and/or activities performed;
themes and/or entities extracted from said contexts;
elements of dialogue identified within said contexts;
time periods of use associated with said contexts;
possible actions associated with said contexts.

4. The method according to claim 3, wherein said analysis takes into account a number of criteria satisfied by said reference contexts during said multi-criteria similarity analysis.

5. The method according to claim 1, wherein said determining comprises determining a plurality of target actions, and ranking said target actions by degree of relevance.

6. The method according to claim 1, wherein said at least one target action belongs to the group consisting of:
launching a particular application installed on the electronic terminal;
launching a particular functionality of said electronic terminal, in relation to at least one of said data of said current digital context.

7. The method according to claim 1, wherein said reference contexts are generated and stored during an initialization phase, on a basis of a preliminary analysis of activity on said electronic terminal.

8. The method according to claim 7, wherein said initialization phase comprises, prior to said preliminary activity analysis, a step of indexing content of said electronic terminal.

9. The method according to claim 1, further comprising restituting on the electronic terminal a suggestion for execution of said at least one target action.

10. The method according to claim 9, wherein the determining a target action takes into account a history of target actions executed following execution suggestions restituted during an implementation of at least one previous iteration of said steps of obtaining, analyzing, determining and restituting.

11. A device comprising:
At least one processor; and
At least one non-transitory computer readable medium comprising instructions stored thereon which when executed by the at least one processor configure the device to determine at least one target action from a set of actions able to be executed on an electronic terminal, by:
obtaining a current digital context of use of said electronic terminal, said current digital context comprising data related to a current use of said electronic terminal, at least part of said data being obtained by the implementation of character recognition techniques and automatic language processing techniques on elements displayed on a screen of said electronic terminal;
analyzing at least one criterion of similarity between said current digital context and a plurality of previously stored reference contexts, said analysis being carried out at least on the basis of said part of said data obtained by the implementation of character recognition techniques and automatic language processing techniques on elements displayed on a screen of said electronic terminal, delivering at least one context of highest degree of similarity with said current digital context from said reference contexts, referred to as similar context; and
determining said at least one target action by comparing said current digital context and said at least one similar context.

12. A non-transitory computer readable medium comprising a computer program product stored thereon comprising program code instructions for executing a method for determining at least one target action from a set of actions able to be executed on an electronic terminal, when executed by a computing machine, the method comprising at least one iteration of:
obtaining a current digital context of use of said electronic terminal, said current digital context comprising data related to a current use of said electronic terminal, at least part of said data being obtained by the implementation of character recognition techniques and automatic language processing techniques on elements displayed on a screen of said electronic terminal;
analyzing at least one criterion of similarity between said current digital context and a plurality of previously stored reference contexts, said analysis being carried out at least on the basis of said part of said data obtained by the implementation of character recognition techniques and automatic language processing techniques on elements displayed on a screen of said electronic terminal, said analysis delivering at least one context of highest degree of similarity with said current digital context from said reference contexts, referred to as similar context; and
determining said at least one target action by comparing said current digital context and said at least one similar context.
